(19) United States
(12) Patent Application Publication
(10) Pub. No.: US 2016/0243732 A1
(43) Pub. Date: Aug. 25, 2016

(54) METHOD FOR THE MANUFACTURING OF A RIM RING, METHOD FOR THE FIXING OF SPOKES, RIM, IN PARTICULAR CLINCHER-RIM, AND BICYCLE

(71) Applicant: CarboFibretec GmbH, Friedrichshafen (DE)

(72) Inventors: Erhard WISSLER, Bissingen/Teck (DE); Thomas LESCHIK, Meckenbeuren (DE)

(21) Appl. No.: 15/011,139

(22) Filed: Jan. 29, 2016

(30) Foreign Application Priority Data
Feb. 20, 2015 (DE) 10 2015 102 465.9
Feb. 20, 2015 (DE) 10 2015 102 466.7

(51) Int. Cl. B29C 43/02

(52) U.S. Cl. CPC B29C 43/027; B29C 2043/028; B29L 2031/3091

(57) ABSTRACT

A method for the manufacturing a rim with a layer structure for a muscle-powered vehicle is disclosed. The method includes providing a first, pressure and temperature resistant mould. A first plane reinforcement fibre package consisting of at least two separate layers of reinforcement fibres is inserted into the first mould. One or several reinforcement fibre mat(s) are inserted into the first mould onto the first reinforcement fibre package. A second flat reinforcement fibre package consisting of at least two separate layers of reinforcement fibres is inserted into the first mould onto the one or several reinforcement fibre mat(s). A spacer is inserted into the first mould and the first mould is closed by means of a second, pressure and temperature-resistant mould. The layered structure is hardened and the rim may be removed from the moulds. Rims, running wheel and bicycles manufactured using the described process are also disclosed.

### CROSS-REFERENCE TO RELATED APPLICATIONS

This Application claims priority of DE Application Nos.: 10 2015 102 465.9 and 10 2015 102 466.7, both filed on Feb. 20, 2015. Each of these priority applications is incorporated herein by reference in their entirety.

### FIELD OF THE INVENTION

The invention concerns a method for the manufacturing of a rim with a layer structure for a muscle-powered vehicle, such as a bicycle.

From the state of the art, a method for the manufacturing of a rim is known from DE 10 2007 042 198 A1. There, a method for the manufacturing of a rim ring for a tire rim, in particular for a clincher-rim, is proposed in particular.

There, the following steps are explained: Providing of an external rim profile made of hardened composite fibre material, providing of a plastic mould element, providing of at least one top layer made of composite fibre material, insertion of the plastic mould element radially inside the external rim profile, and positioning of the top layer relative to the plastic mould element and the external rim profile so that at least one/a part of the top layer extends from the plastic mould element to the outside of the external rim profile. Furthermore, this older printed publication concerns a method for the fixing of spokes made of composite fibre material on a rim ring. Finally, the older printed publication also concerns a rim ring, a clincher-rim and a bicycle with clincher-rims.

A device and a method for the manufacturing of reinforcement fibre products is also known from WO 2011/096805 A1. In particular, toroid-shaped reinforcement fibre composite products are disclosed there.

Rims have been used on vehicles for a long time in order to carry tires. Such rims are used for combustion engine driven vehicles, such as cars, trucks or other utility vehicles, but also muscle-powered vehicles such as bicycles.

In the bicycle section, different materials have proven successful, so-called aluminium rims, steel rims, titanium rims and so-called composite material rims. In general, these composite material rims can be considered rims comprising different materials. A special sub-type of such composite material rims are also fibre composite material rims, that is, such rims for which reinforcement fibres, such as short fibres or long fibres, are used. Usually the fibres are embedded in resin. During the manufacturing process, the resin is hardened in order to create a fully completed rim. It is quite common to process the surface of a finished rim product containing reinforcement fibres in one or several re-processing steps, also of an abrasive kind.

The advantages of fibre composite material rims have become apparent in the past 20 years. Such rims are more light-weight and stiffer as compared to rims made of other materials after all. Such rims have proven successful in the high-end segment of racing bikes, triathlon bikes and mountain bikes in particular.

Unfortunately the fibre composite material rims available to date are still too expensive and can be further optimised with regard to stiffness and light weight.

This is addressed by the invention, which makes a point of eliminating or at least mitigating these known disadvantages. In particular, a rim that can be machine-produced and a method that can be used to produce it are to be introduced, that increases cost potentials and improves the rim as far as stiffness and light weight as compared to conventional rims are concerned.

This problem is solved according to the invention with a method comprising the steps of the following kind that preferably take place one after the other:
a) Providing a first, possibly pressure- and temperature-resistant mould, for example made of a steel alloy,
b) Inserting a first plane reinforcement fibre package consisting of at least two separate layers, such as in the style of a knitted, meshed, woven or non-woven fabric, such as comprising or consisting of glass fibres, aramid fibres and/or carbon fibres, into the first mould,
c) Inserting one or several reinforcement fibre mat(s), mostly made of reinforcement fibres, into the first mould onto the first reinforcement fibre package,
d) Inserting a second plane reinforcement fibre package consisting of at least two separate layers, such as in the style of a knitted, meshed, woven or non-woven fabric, such as comprising or consisting of glass fibres, aramid fibres and/or carbon fibres, into the first mould onto the one or several reinforcement fibre mat(s),
e) Inserting a spacer into the first mould,
f) Closing the first mould by means of a second pressure- and temperature-resistant mould, for example made of a steel alloy, and
g) Hardening, for example by means of pressure and/or temperature increase, the layered structure containing reinforcement fibre obtained by the steps performed before, opening of the first and/or second mould(s) and taking out the rim.

Such a complex layer/layered structure can easily be realised with machines. This shortens the production time. Although the weight of the rim is not changed substantially as compared to the known most light-weight rims, a significant increase on stiffness is achieved. The stiffness coefficients available on the market to date are exceeded by far. Still the convenience characteristics do not deteriorate but improve because of a load-adjusted design.

Advantageous embodiments are claimed in the sub-claims and will be explained in more detail below.

For example, it is advantageous when a first continuous double-laid fabric/material, such as a knitted, meshed, woven or non-woven fabric made of reinforcement fibres, such as comprising or consisting of glass fibres, aramid fibres or carbon fibres, folded/turned down along a line/(spatial) curve/edge/straight line is inserted in the first mould before step b) and/or after step a). Then a particularly need-oriented fibre orientation/alignment can be realised.

For the load capacity of the rim, it is advantageous when a second continuous double-laid fabric, such as a knitted, meshed, woven or non-woven fabric made of reinforcement fibres, such as comprising or consisting of glass fibres, aramid fibres or carbon fibres, folded/turned down along a line/(spatial) curve/edge/straight line is inserted in the first mould onto the second reinforcement fibre package before step f) and/or after step e).

When the spacer is realised as an inflatable hose, such as a rubber, natural rubber or silicone hose, a piece of foam, such as a polymethacrylimide structure, that is, a polymer from which hard plastic (PMI) and hard foam (PMI-E) are made, and belonging to the polyimides, in particular a piece of so-called Rohacell-foam, and/or an incompressible plastic component, such as a (thermosetting) resin component comprising (short) glass fibres, the rim flanges can be realised/shaped particularly precisely and loadable.

For force absorption, it is advantageous when the reinforcement fibres of the first double-laid fabric and/or the second double-laid fabric mainly have an arrangement that is predominantly aligned parallel to the circumferential direction of the rim, i.e. have an angle of approx. ±5° or approx. 0° to the circumferential direction.

An advantageous exemplary embodiment is also characterised in that the reinforcement fibres in the first reinforcement fibre package and/or in the second fibre reinforcement package mostly have an arrangement that is predominantly aligned orthogonal to the circumferential direction of the rim, i.e. have an angle of approx. 80° to approx. 100° to the circumferential direction of the rim, preferably 85°, 90° or 95°. Then a rim that is particularly loadable and stiff in the axial direction can be created.

It is expedient when the first reinforcement fibre package and/or the second reinforcement fibre package (each) has/have three layers separated from each other at least in the axial direction, for example in the style of a knitted, meshed, woven or non-woven fabric made of reinforcement fibres, for example comprising or consisting of glass fibres, aramid fibres or carbon fibres.

There, it is very advantageous when the middle one of the three layers has reinforcement fibres in a 95° orientation relative to the circumferential direction and the two layers adjacent to that/abutting that have reinforcement fibres in a 85° orientation. Deviations from ±1° to 2° are totally acceptable.

When a sharp-edged auxiliary contouring layer is positioned on the spacer directly after step e) and/or directly before step f), over which the layer structure obtained at that point in time is folded/turned over/folded down, the rim becomes especially side rigid.

It is advantageous when the auxiliary contouring layer is folded/turned over/folded down on both axial ends around the spacer so that the lateral ends of the obtained layer structure are facing towards each other. This makes it easier to reach/engage behind a clincher which is to be fixed on the rim.

The load capacity in the area of the clincher-fixing is increased when the axial ends of the layer structure overlap or are constantly distanced from each other in the circumferential direction as seen in the axial direction by a gap, which makes it easier to take out the spacer in this embodiment. With the last alternative, manufacturing can also be accelerated time-wise.

For efficient manufacturing, it is advantageous when the reinforcement fibres are pre-impregnated with resin, such as epoxy resin, thermoset resin or thermoplastic resin, or are “dry” in order to be impregnated with (such) resin in a separate impregnation step.

It is advantageous when the first mould is divided up at least in the axial direction, for example in two halves, and/or the second mould is divided up in the circumferential direction at one joint each, preferably in three identically dimensioned parts. This makes the assembly and the insertion of the individual layers easier.

When the aerodynamic characteristics of the rim do not have priority, it is advantageous to drill spoke attachment holes and/or a valve through-hole on the radial inside of the rim indirectly or directly after step g). Then a particularly light-weight rim can be designed.

For the manufacturing of a loadable (running) wheel in an efficient way, it is advantageous to attach first spokes in a spot at an axial distance from second spokes on a rim, for example laminate them on the rim.

A good positioning of the individual components without free space in between can be achieved by performing a vacuum creating step indirectly or directly before step f). For that purpose, a cover with a three-part radial sleeve can be inserted. Furthermore, covering with a bag is conceivable in this connection.

In order to make is possible that the spacer can be taken out easily and to produce loadable rim flanges at the same time, it is advantageous to perform a milling of the radial outside of the rim to create rim flanges indirectly or directly after step f). As an alternative to milling, a turning process can also be performed.

An advantageous exemplary embodiment is also characterised in that foam wedges are attached, for example glued on, on the radial inside, for example by means of an adhesive tape attached in a spiral way.

It is furthermore expedient to cover the area of the future brake flank, preferably on the foam wedges, with a reinforcement fibre layer, like in the style of knitted, meshed, woven or non-woven fabric.

In order to enable good speed determination or cadence determination later too, it is advantageous to insert a (permanent) magnet, a (magnetic) sensor, an RFID chip, a counterweight and/or a valve tube in the rim or in one of the foam wedges.

When the foam wedges and/or the rim are/is covered with a reinforcement fibre mat, the reinforcement fibres of which are arranged (predominantly) nearly or precisely in the circumferential direction, the load capacity of an aerodynamically optimised rim is improved.

For the cohesion of the prefabricated individual components, it is advantageous to fix/put on reinforcement fibre patches in the area of the anticipated spokes.

It is of advantage when a crash protection fibre, for example made of thermoplastic material, is positioned in the area of the foam wedges, preferably centrally in the radial direction on said foam wedges.

For a faster detection of a “worn-down” rim, it is of advantage when an aramid fibre section is positioned and fixed in the area of (only/precisely) one brake flank. Such an aramid fibre section may be followed by another aramid fibre section in the circumferential direction, i.e. tangential direction. There, it is advantageous when such an aramid fibre section is present on only one single brake flank because then the weight is not increased unnecessarily.

It is conducive for stability when an additional spoke fixing system made of spiral fabric/spiral mesh is used to enable spoke insertion and/or a valve insert.

It is expedient when a step of the (resin) infiltration and increasing the pressure and/or temperature is used to achieve a hardening of the (running) wheel.

The invention also concerns a rim for a muscle-powered vehicle, such as a bicycle, with a layer structure, manufactured based on a method according to the invention.

The invention also concerns a (running) wheel with a rim of the type described above and/or a method (of the type) according to the invention.

Ultimately, the invention also concerns a bicycle with a (running) wheel as described above or a rim as described above.

Below, the invention is explained in more detail based on a drawing, in which a first embodiment of a rim according to the invention, manufactured based on the method according to the invention, is visualised.

Only a cross-section, transversely to the circumferential direction (i.e. along the radial direction) of the rim is shown, i.e. in the still unfinished state before hardening and taking out of a mould, and before possible post-processing/finishing.

The FIGURE is only of a schematic nature and only serves to provide an understanding of the invention. The FIGURE is an overlayed presentation of steps that are carried out consecutively and shows, on the one hand, how the rim is placed in a mould, and on the other hand, how the individual layers are aligned before the mould is closed.

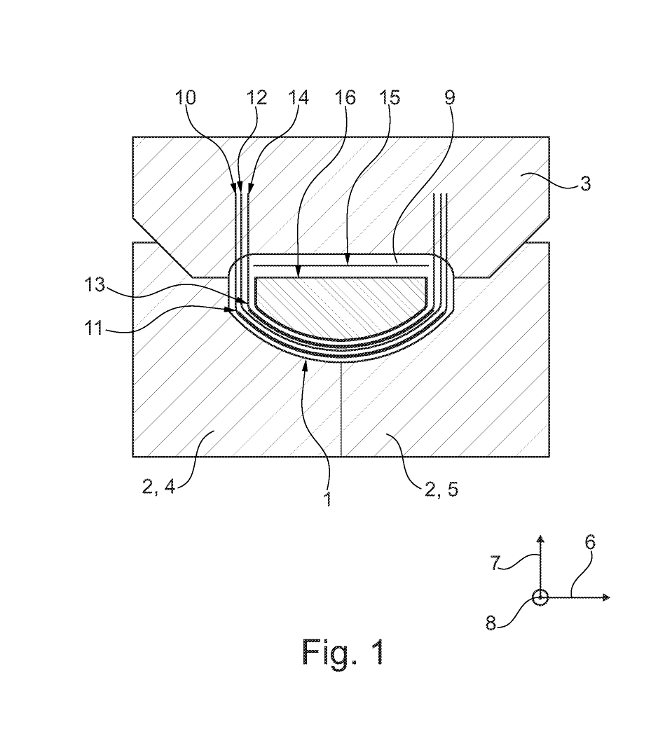

FIG. 1 shows a section of a rim 1 according to the invention. The rim 1 is arranged above a first mould 2 and below a second mould 3. The second mould 3 can also be referred to as a sleeve.

The first mould 2 is divided up in a first ring 4 and a second ring 5 along a plane running in the circumferential direction and positioned orthogonally to an axial direction. The axial direction is symbolically indicated with arrow 6, whereas the radial direction is symbolically indicated with arrow 7. The circumferential direction is symbolically indicated with arrow 8.

Between the first mould 2 and the second mould 3, a hollow space 9 is defined within which the individual layers of a layer structure of the rim 1 are inserted and/or positioned.

A first reinforcement fibre package 10 is placed/inserted in the first mould 2, whereby it is possible to additionally place a first double-laid fabric in between which is not shown in the drawing. In the area of the separating plane between the two rings 4 and 5 and axially adjacent to that and radially outside the radially innermost rim area, a zero-degree reinforcement fibre layer 11 is spaced at a distance, followed by another zero-degree reinforcement fibre layer 12 and another zero-degree reinforcement fibre layer 13, which then is adjacent to the next radially outside adjacent layer, namely a second reinforcement fibre package 14. The zero-degree reinforcement layers 11, 12 and 13 can also be referred to as reinforcement fibre mats.

The two reinforcement fibre packages 10 and 14 each consist of three reinforcement fibre layers that are separate from each other with an 85°, 95° and 85° orientation.

An auxiliary contouring layer 15, for example made of a sharp-edged glass fibre strip, is positioned radially outside a spacer 16. As mentioned regarding the FIGURE in the beginning, the distal ends of the zero-degree reinforcement layers 11, 12 and 13 are laid around the axial end face of the auxiliary contouring layer 15 so that the distal ends of the zero-degree reinforcement layers 11, 12 and 13 are in contact with each other, overlap each other or are axially distanced from each other. The state that is given then is not shown as such in the FIGURE.

The two moulds 2 and 3 are made of a steel alloy component. The reinforcement fibres of the individual layers are (long) carbon fibres.

1. A method for the manufacturing of a rim with a layer structure for a muscle-powered vehicle, comprising the steps:
a) Providing a first, pressure- and temperature-resistant mould,
b) Inserting a first plane reinforcement fibre package consisting of at least two separate layers of reinforcement fibres into in the first mould,
c) Inserting one or several reinforcement fibre mat(s) into the first mould onto the first reinforcement fibre package,
d) Insertion of a second plane reinforcement fibre package consisting of at least two separate layers of reinforcement fibres into the first mould onto the one or several reinforcement fibre mat(s),
e) Inserting a spacer into the first mould,
f) Closing the first mould by means of a second, pressure- and temperature-resistant mould, and
g) Hardening the layered structure containing reinforcement fibres obtained by the steps performed before, opening the first and/or second mould(s) and taking out the rim.

2. A method according to claim 1, characterised in that a first continuous double-laid fabric made of reinforcement fibres folded along a line is inserted into the first mould before step b) and/or after step a).

3. A method according to claim 1, characterized in that a second continuous double-laid fabric made of reinforcement fibres folded along a line is inserted into the first mould onto the second reinforcement fibre package before step f) and/or after step e).

4. A method according to claim 1, characterized in that the spacer is designed as an inflatable hose, a piece of foam and/or an incompressible plastic component.

5. A method according to claim 2, characterised in that the reinforcement fibres of the first double-laid fabric and/or the second double-laid fabric mostly have an arrangement that is predominantly oriented parallel to the circumferential direction of the rim.

6. A method according to claim 1, characterised in that the reinforcement fibres in the first reinforcement fibre package and/or in the second reinforcement fibre package mostly have an arrangement that is predominantly oriented orthogonal to the circumferential direction of the rim.

7. A method according to claim 1, characterised in that the first reinforcement fibre package and/or the second reinforcement fibre package is/are formed of three layers of reinforcement fibres, which are separated from each other in the axial direction.

8. A rim for a muscle-powered vehicle, such as a bicycle, with a layered structure, manufactured based on the method according to claim 1.

9. A running wheel with a rim according to claim 8.

10. A bicycle with a running wheel according to claim 9.

11. A bicycle with a rim according to claim 8.
